(19) United States
(12) Patent Application Publication
(10) Pub. No.: US 2025/0371425 A1
(43) Pub. Date: Dec. 4, 2025

(54) LEARNING TO CLASSIFY MALICIOUS USER MESSAGES BASED ON MULTIPLE INSTANCE LEARNING

(71) Applicant: SRI International, Menlo Park, CA (US)

(72) Inventors: John CADIGAN, San Diego, CA (US); Martin GRACIARENA, Belmont, CA (US); Alan TAITZ, Redwood City, CA (US)

(21) Appl. No.: 19/223,895

(22) Filed: May 30, 2025

Related U.S. Application Data
(60) Provisional application No. 63/654,730, filed on May 31, 2024.

(51) Int. Cl. G06N 20/00; G06F 40/30

(52) U.S. Cl. CPC G06N 20/00; G06F 40/30

(57) ABSTRACT

A method, apparatus and system to train a MIL text classification model for classifying a text content bag includes determining a first classification estimate for text content instances of the text content bags using bag-level information, determining a second classification estimate for the text content instances of the text content bags using the first classification estimates by applying a contrastive learning technique, determining a pseudo classification label for each of the text content instances of the text content bags using the second classification estimates, determining a combined loss including a first loss associated with a bag constraint loss determined from a bag index of each text content instance, a second loss associated with the contrastive learning technique, and a third loss associated with the determination of the pseudo classification label, and guiding the training of the MIL classifier using the combined loss.

### CROSS-REFERENCE TO RELATED APPLICATION

This application claims benefit of and priority to U.S. Provisional Patent Application Ser. No. 63/654,730, filed May 31, 2024, which is herein incorporated by reference in its entirety.

### GOVERNMENT RIGHTS

This invention was made with Government support under Contract Number HR001120C0124 awarded by the Defense Advanced Research Projects Agency (DARPA). The Government has certain rights in the invention.

### FIELD

Embodiments of the present principles generally relate to multiple instance learning and, more particularly, to a method, apparatus and system for classifying text content based on multiple instance learning.

### BACKGROUND

In machine learning, multiple-instance learning (MIL) is a type of supervised learning. Instead of receiving a set of instances which are individually labeled, the learner receives a set of labeled bags, each containing many instances. In the simple case of multiple-instance binary classification, a bag may be labeled negative if all the instances in it are negative. On the other hand, a bag is labeled positive if there is at least one instance in it which is positive. From a collection of labeled bags, a learner tries to either (i) induce a concept that will label individual instances correctly or (ii) learn how to label bags without inducing the concept.

Weakly supervised approaches based on Multiple Instance Learning (MIL) have become the mainstream in the field of deep learning-based image processing, such as whole slide image (WSI) processing. In the MIL setting, each WSI is regarded as a bag, and the small patches cut out of the bag are regarded as instances of the bag. In WSI processing, bag-based methods first use an instance-level feature extractor to extract features for each instance in a bag and then aggregate these features to obtain a bag-level feature, which is used to train a bag classifier. Most recent bag-based methods utilize attention mechanisms to aggregate instance features and introduce an independent scoring module to generate learnable attention weights for each instance feature, which can be used to realize instance-level classification. Although this type of method overcomes the problem of noisy labels in instance-based methods, it has issues with low performance in instance-level classification. That is, there exists difficulty of identifying different positive instances in the same positive bag (e.g., instances with larger tumor areas are easier to be identified than those with smaller tumor areas). Attention-based methods define losses at the bag level, which often leads to the result that only the most easily identifiable positive instances are found through the high attention scores while other more difficult ones are missed.

Further issues include that bag-level classification performance is not robust. That is, bag-level classification relies heavily on the attention scores assigned by the scoring network to each instance. When these attention scores are inaccurate, the performance of the bag classifier will also be affected. A typical example is the bias that occurs in classifying bags with a large number of difficult positive instances while very few easy positive instances. In addition, another issue includes that the current bag classification solutions have not been applied to text classification and have only been applied to image classification.

### SUMMARY

Embodiments of the present principles provide methods, apparatuses and systems for training a model to classify text content based on multiple instance learning.

In some embodiments a method for training a multiple instance learning (MIL) classifier for classifying text content bags for including a text content characteristic includes a) determining a first classification estimate for text content instances of the text content bags using bag-level information identifying positive bags and negative bags, b) training the MIL classifier in a first stage using the determined first classification estimates, c) determining a second classification estimate for the text content instances of the text content bags using the first classification estimates by applying a contrastive learning technique to distinguish between similar and dissimilar data points, d) training the MIL classifier in a second stage using the determined second classification estimates, e) determining a pseudo classification label for each of the text content instances of the text content bags using the second classification estimates, f) training the MIL classifier in a third stage using the determined pseudo classification labels, g) determining a combined loss including a first loss associated with a bag constraint loss determined from a bag index of each text content instance, a second loss associated with the contrastive learning technique, and a third loss associated with the determination of the pseudo classification label, h) guiding the training of the MIL classifier using the combined loss, i) paraphrasing at least one of the text content instances in the text content bags to create at least one new text content instance, and j) repeating steps a) through h) to train the MIL classifier using the at least one new text content instance.

In some embodiments, a method for classifying a text content bag includes receiving a text content bag including text content instances, and applying a trained multiple instance learning (MIL) text classification model to the received text content bag to determine if the text content bag is positive or negative for a text characteristic, wherein the MIL text classification model is trained using a method including a) determining a first classification estimate for text content instances of the text content bags using bag-level information identifying positive bags and negative bags, b) training the MIL classifier in a first stage using the determined first classification estimates, c) determining a second classification estimate for the text content instances of the text content bags using the first classification estimates by applying a contrastive learning technique to distinguish between similar and dissimilar data points, d) training the MIL classifier in a second stage using the determined second classification estimates, e) determining a pseudo classification label for each of the text content instances of the text content bags using the second classification estimates, f) training the MIL classifier in a third stage using the determined pseudo classification labels, g) determining a combined loss including a first loss associated with a bag constraint loss determined from a bag index of each text content instance, a second loss associated with the contrastive learning technique, and a third loss associated with the determination of the pseudo classification label, h) guiding the training of the MIL classifier using the combined loss, i) paraphrasing at least one of the text content instances in the text content bags to create at least one new text content instance, and j) repeating steps a) through h) to train the MIL classifier using the at least one new text content instance.

In some embodiments, an apparatus for training a multiple instance learning (MIL) classifier for classifying text content bags includes a processor and a memory accessible to the processor, the memory having stored therein at least one of programs or instructions. In some embodiments, when the programs or instructions are executed by the processor, the apparatus is configured to a) determine a first classification estimate for text content instances of the text content bags using bag-level information identifying positive bags and negative bags, b) train the MIL classifier in a first stage using the determined first classification estimates, c) determine a second classification estimate for the text content instances of the text content bags using the first classification estimates by applying a contrastive learning technique to distinguish between similar and dissimilar data points, d) train the MIL classifier in a second stage using the determined second classification estimates, e) determine a pseudo classification label for each of the text content instances of the text content bags using the second classification estimates, f) train the MIL classifier in a third stage using the determined pseudo classification labels, g) determine a combined loss including a first loss associated with a bag constraint loss determined from a bag index of each text content instance, a second loss associated with the contrastive learning technique, and a third loss associated with the determination of the pseudo classification label, and h) guide the training of the MIL classifier using the combined loss.

In some embodiments, an apparatus for classifying a text content bag includes a processor and a memory accessible to the processor, the memory having stored therein at least one of programs. In some embodiments, when the programs or instructions are executed by the processor, the apparatus is configured to receive a text content bag including text content instances and apply a trained multiple instance learning (MIL) text classification model to the received text content bag to determine if the text content bag is positive or negative for a text characteristic, wherein the MIL text classification model is trained using a method including a) determining a first classification estimate for text content instances of the text content bags using bag-level information identifying positive bags and negative bags, b) training the MIL classifier in a first stage using the determined first classification estimates, c) determining a second classification estimate for the text content instances of the text content bags using the first classification estimates by applying a contrastive learning technique to distinguish between similar and dissimilar data points, d) training the MIL classifier in a second stage using the determined second classification estimates, e) determining a pseudo classification label for each of the text content instances of the text content bags using the second classification estimates, f) training the MIL classifier in a third stage using the determined pseudo classification labels, g) determining a combined loss including a first loss associated with a bag constraint loss determined from a bag index of each text content instance, a second loss associated with the contrastive learning technique, and a third loss associated with the determination of the pseudo classification label, h) guiding the training of the MIL classifier using the combined loss, i) paraphrasing at least one of the text content instances in the text content bags to create at least one new text content instance, and j) repeating steps a) through h) to train the MIL classifier using the at least one new text content instance.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of the scope, for the principles may admit to other equally effective embodiments.

FIG. 1 depicts a high-level block diagram of a multiple instance learning (MIL) text classification system in accordance with an embodiment of the present principles.

FIG. 2 depicts a functional representation of a primary architecture/technique of a MIL text classification system in accordance with an embodiment of the present principles.

FIG. 3 depicts a timing diagram of an iterative process of an embodiment of the training of an MIL classification model in accordance with an embodiment of the present principles.

FIG. 4A depicts a flow diagram for training a MIL text classification model to classify text content bags as positive or negative for a specific text characteristic in accordance with an embodiment of the present principles.

FIG. 4B depicts a flow diagram for training a MIL text classification model to classify text content bags as positive or negative for a specific text characteristic in accordance with an embodiment of the present principles

FIG. 5 depicts a flow diagram of a method for classifying text content bags in accordance with an embodiment of the present principles.

FIG. 6 depicts a computing device suitable for use with embodiments of a MIL text classification system in accordance with the present principles

FIG. 7 depicts a high-level block diagram of a network in which embodiments of a MIL text classification system in accordance with the present principles, can be applied.

FIG. 8 depicts a Table of results of a sentence-level-trained classifier, a bag-level-trained classifier and a MIL classifier trained in accordance with the present principles when applied to evaluation data in accordance with an embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for Multiple Instance Learning (MIL) text content classification. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to the classification of text content including words, phrases and sentences, such teachings should not be considered limiting. Embodiments in accordance with the present principles can function for training a model to classify substantially any text content.

Embodiments in accordance with the present principles include a multi-tier process for training and implementing a learning model, in some embodiments including at least a bag-level learning process, a contrastive learning process, and a pseudo-instance learning process. In some embodiments, during bag level training a model is trained solely based on the labels of entire sets of data (bags), rather than individual instances within those bags, in which a bag is classified based on its most positive instance, if any exist. The model learns to associate features of entire bags with their overall labels without needing to know the specific instances within the bags that are positive or negative, as in traditional supervised learning.

In some embodiments, during contrastive learning unlabeled data points are juxtaposed against each other to teach a model which points are similar and which are different. That is, contrastive learning works by training the model to distinguish between similar and dissimilar data instances by contrasting similar and dissimilar data instance examples, which helps the model learn more inter-class separable text features (e.g., semantic features). In the context of an MIL text classifier of the present principles, contrastive learning is used to train a model to learn representations in which instances from the same bag (or class) are closer in an embedding space, while instances from different bags (or classes) are further apart.

In some embodiments, during pseudo instance learning, predicted labels are assigned to instances within a bag based on a model's predictions, treating the assigned labels as if they were true labels for training purposes. The predicted labels are considered “pseudo-labels” and used to train the model again and again. That is, the pseudo-labels are used to iteratively refine a model's understanding of instance-level relationships within the bags.

In some embodiments, at least one instance-level text content is paraphrased and the process is reiterated to further train a model using the new instance created during the paraphrasing of the at least one instance-level text content.

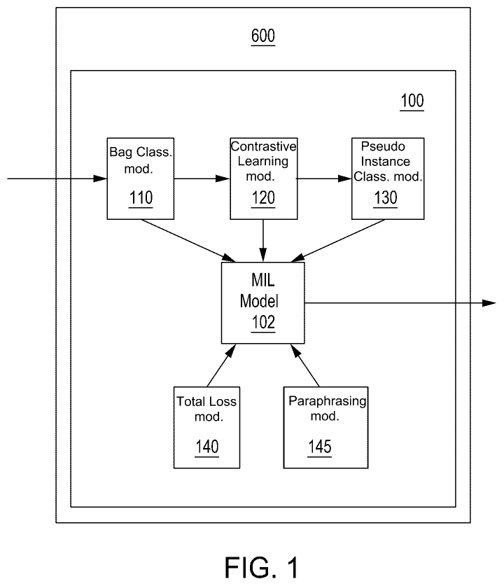

FIG. 1 depicts a high-level block diagram of a multiple instance learning (MIL) text classification system 100 in accordance with an embodiment of the present principles. The MIL text classification system 100 of FIG. 1 illustratively comprises a bag classification module 110, a contrastive learning module 120, a pseudo instance classification module 130, a total loss module 140, and a paraphrasing module 145. In the embodiment of the MIL text classification system 100 of FIG. 1, the bag classification module 110, the contrastive learning module 120 comprises, the pseudo instance classification module 130, the total loss module 140 and the paraphrasing module 145 train a MIL classification model 102 of the present principles. Although in the embodiment of FIG. 1, the MIL classification model 102 is depicted as a single model, in some embodiments of the present principles, the MIL classification model can include more than one model.

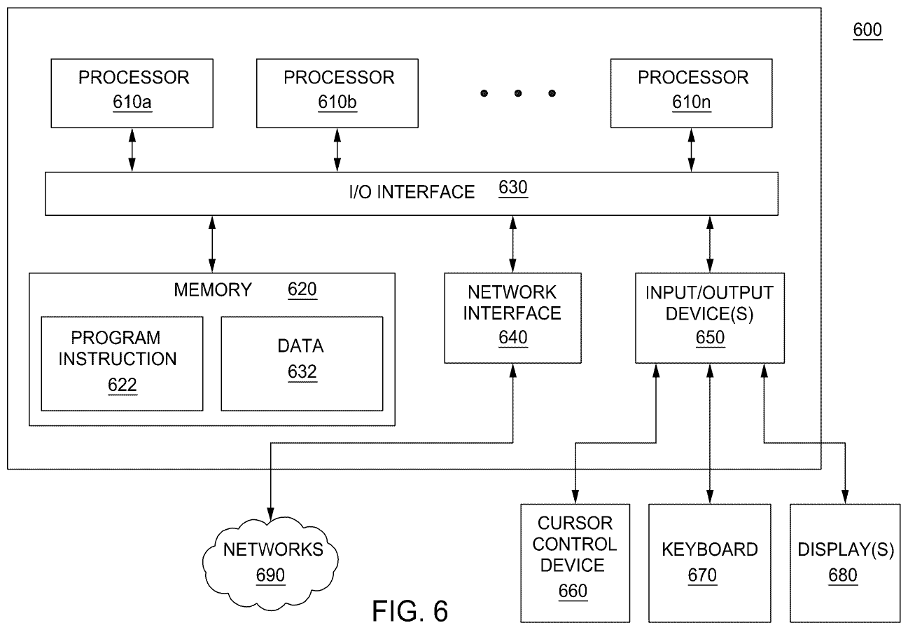

As further depicted in FIG. 1, embodiments of a MIL text classification system of the present principles, such as the MIL text classification system 100 of FIG. 1, can be implemented via a computing device 600 in accordance with the present principles (described in greater detail below with respect to FIG. 6).

In embodiments of the present principles, instead of receiving a set of instances which are individually labeled, a MIL text classification system of the present principles, such as the MIL text classification system 100 of FIG. 1, can receive a set of labeled bags, each containing many instances. In the simple case of multiple-instance binary classification, a bag is labeled negative if all the instances in it are negative and a bag is labeled positive if there is at least one instance in it which is positive. For example, in some embodiments, a training/received dataset, X={X1, X2, . . . , X_{N}}, can contain N instances of text content, for example user messages, and each user message can be divided into non-overlapping patches {Xᵢ j, j=1, 2, . . . nᵢ}, where ni denotes the number of patches obtained from Xᵢ. In such embodiments, all the patches from Xᵢ constitute a bag, where each patch is an instance of this bag in which each patch can contain at least one word or a phrase of the total text content. The label of the bag Yᵢ∈{0, 1}, i={1, 2, . . . . N}, and the labels of each instance {y_{i,j}, j=1, 2, . . . ni} have the relationship according to equation one (1), which follows:

$${Y}_{i} = \{ \begin{matrix}0 , & if {\sum }_{j} {y}_{ij} = 0 \\ 1 , & Else\end{matrix} . \qquad ( 1 )$$

Equation (1) indicates that all instances in negative bags are negative, while in positive bags, there exists at least one positive instance. In the setting of weakly supervised MIL, only the labels of bags in the training set are available, while the labels of instances in positive bags are unknown. One goal is to accurately predict a label for each bag (bag classification).

In accordance with the present principles, an instance can include any level of text content and a bag will include a higher level of text content. For example, in some embodiments, an instance can include a word and a bag can include a collection of words, such as a sentence, a phrase, a document(s) and the like. Alternatively or in addition, in some embodiments, an instance can include higher level text content such as a sentence, and a bag can include a phrase, a document(s), or any other higher-level text content. Such examples should not be considered limiting and there is no limit to the text content that can be included in an instance and/or a bag in a MIL text classification system of the present principles, such as the MIL text classification system 100 of FIG. 1.

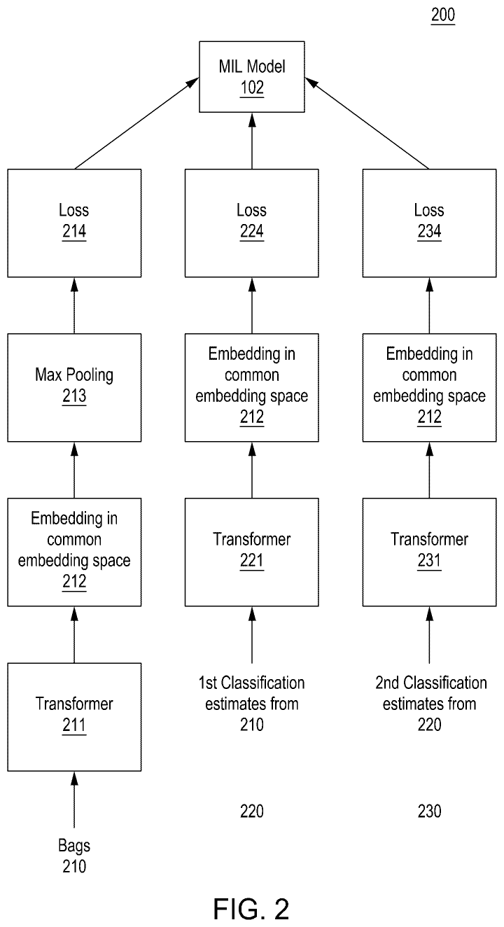

FIG. 2 depicts a functional representation 200 of a primary architecture/technique of a MIL text classification system of the present principles, such as the MIL text classification system 100 of FIG. 1, in accordance with an embodiment of the present principles. The functional embodiment 200 of the MIL text classification system of FIG. 2 illustratively includes a bag classification portion 210, a contrastive learning portion 220, and a pseudo instance classification portion 230. In the embodiment of FIG. 2, in the bag classification portion 210, the bag classification module 110 receives labeled bag information. That is, the bag classification module receives content bags including labels identifying the bags as either positive (including at least one instance containing a content characteristic of interest) or negative (no instances contain the content characteristic of interest). In accordance with the present principles, instances in negative bags are all identified as negative instances, while instances in positive bags can be either negative or positive instances. In the bag classification portion 210, a first estimated classification is learned from the extreme data points (e.g., most positive and negative text content).

More specifically, in the embodiment of FIG. 2, the labeled bag information can be communicated to a transformer 211 of the bag classification module 110 in which vector representations can be generated based on the content characteristics (e.g., features) of at least the negative content instances of the negative content bags. In the embodiment of FIG. 2, the vector representations of the negative instances of the negative content bags can be embedded in a common embedding space 212 in which similar instances are pushed closer together in the common embedding space 212, while dissimilar instances are pushed apart. In some embodiments, such embeddings can be considered a first classification estimate.

In addition, in some embodiments, vector representations can be generated for the text content instances of the bags identified as positive bags as not being negative text content instances. In some embodiments, the vector representations of the text content instances of the positive content bags can be embedded in the common embedding space 212, for example, as not negative text content instances. In the bag classification portion 210 of the embodiment of FIG. 2, the bag classification module 110 performs Max pooling 213 of the embedded information to aggregate instance-level predictions of features within a bag into single bag-level representations. That is, in the embodiment of FIG. 2, the bag classification module 110 aggregates information from the features within each text content instance to create a single representation for that instance, which can then be used to calculate a loss 214. For example, as depicted in the embodiment of FIG. 2, the bag classification module 110 calculates a loss 214 for the embeddings. In a MIL text classification system of the present principles, such as the MIL text classification system 100 of FIG. 1, the MIL classification model 102 is trained using the embeddings associated with the first classification estimate.

In the contrastive learning portion 220 of the embodiment of FIG. 2, the contrastive learning module 120 can determine a second classification estimate for the text content instances of the text content bags. That is, the contrastive learning module 120 can apply a contrastive learning technique to the first classification estimates to distinguish between similar and dissimilar data points. That is, in the contrastive learning portion 220, the contrastive learning module 120 can train the MIL classification model 102 using positive and negative sample sets to learn robust feature representations by pulling positive samples closer and pushing negative samples farther in the common embedding space, such as a semantic embedding space. In some embodiments, to distinguish from the positive and negative instances, the contrastive learning module 120 uses family/non-family sample sets to represent the positive/negative sample sets, respectively.

In the contrastive learning portion 220, true negative instances (e.g. words or phrases) from negative bags are also used to guide the training of the MIL classification model 102. More specifically, in the embodiment of FIG. 2, the contrastive learning module 120 can determine content characteristics (features) of the text content instances identified as negative in the negative text content bags and embedded in the common embedding space 212. During the second classification estimation of the contrastive learning portion 220 of the embodiment of FIG. 2, the contrastive learning module 120 generates vector representations for the text content instances identified as negative text content instances in, for example, the Bag classification portion 210, using a transformer 221 of the contrastive learning module 120. In the embodiment of FIG. 2, the contrastive learning module 120 can further determine content characteristics (features) of the text content instances in bags identified as being positive and determines respective vector representations for each of the text content instances based on the text content characteristics. The contrastive learning module 120 embeds the vector representations of the negative text content instances from the negative bags and the content instances from the positives text content bags having similar features close together in the common embedding space 212. The contrastive learning module 120 embeds the vector representations of the text content instances from the positive bags that have different features than the negative text content instances, farther away from the embedded negative text content instances in the common embedding space 212. That is, in the common embedding space 212, similar instances are pushed closer together in the common embedding space 212, while dissimilar instances are pushed apart.

In the embodiment of FIG. 2, the contrastive learning module 120 further calculates a loss 224 for the embeddings. In a MIL text classification system of the present principles, such as the MIL text classification system 100 of FIG. 1, the MIL classification model 102 is trained using the embeddings associated with the second classification estimate of the contrastive learning portion 220.

In the embodiment of FIG. 2, in the pseudo instance classification portion 230, the pseudo instance classification module 130 can determine pseudo labels for at least the unclassified text content instances. That is, in the pseudo instance classification portion 230 of the embodiment of FIG. 2, the pseudo instance classification module 130 can generate pseudo labels for at least the positive text content instances from the contrastive learning portion 220, specifically from the contrastive learning module 120 of the MIL text classification system 100 of FIG. 1. That is, as described above, in the contrastive learning portion 220, negative text content instances from negative text content bags are classified as truly negative and text content instances from positive bags having similar features to the truly negative bags were also classified as negative text content instances. However, the text content instances having features not similar to the truly negative bags were separated in the common embeddings space 212 from the classified negative text content instances. In the pseudo instance classification portion 230 of the embodiment of FIG. 2, the pseudo instance classification module 130 can generate pseudo labels for at least the positive text content instances based on for example, in some embodiments, a distance of the embedded vector representations of the instances of the positive bag(s) from the embedded vector representations of the negative text content instances of the negative text content bags. The labeled text content instances can be embedded in the common embedding space 212 based on their labels (features).

In some embodiments of the present principles, the pseudo instance classification module 130 can determine a weight for a pseudo label generated for a text content instance based on a degree of similarity or difference between a subject text content instance and an embedded vector representation of at least one negative text content instance. That is, in some embodiments the pseudo instance classification module 130 can calculate a probability assignment between two classes (e.g., negative and positive classes). For example, in an embodiment in which the features of a text content instance from a positive bag has features that are 40% similar to a negative text content instance, the text content instance can be weighted as 60% positive and/or 40% negative and, as such, determined as overall positive.

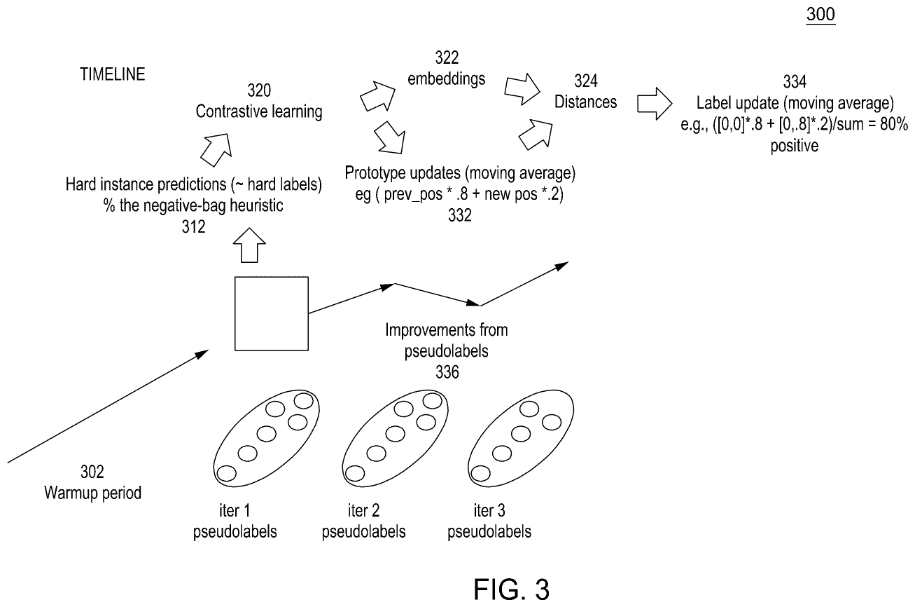

In some embodiments, a pseudo instance classification of the present principles can include rolling prototype vectors, such as a moving average. That is, the pseudo-labels of the present principles can be used iteratively to refine a MIL classification model of the present principle's understanding of instance-level relationships within the bags. For example, FIG. 3 depicts a timing diagram of an iterative process of an embodiment of the training of an MIL classification model in accordance with an embodiment of the present principles. As depicted in the embodiment of FIG. 3, during a warmup period 302 (e.g., a first iteration), the instance accuracy of a MIL classification model of the present principles increases with bag level training 310, which results in hard instance predictions (hard labels) 312 for the negative bag heuristics. During the contrastive learning 320 (as described above) embeddings 322 occur in a common embedding space to distinguish between similar and dissimilar data points by separating such points by distance 324 in the common embedding space. In the embodiment of FIG. 3, the embeddings 322 are updated during pseudo instance learning and a prototype vector 332 is created. During subsequent iterations, the prototype vector 332 is updated for example as a moving average of prototype vectors over iterations. Pseudo labels are created and updated 334 as the iterations improve the distance measurements between the instance embeddings of, for example, the negative and the positive and the positive and the positive labeled instances. As depicted in FIG. 3, in accordance with the present principles, the accuracy of the MIL classification model of the present principles improves 336 with the passing iterations and as the pseudo labels are updated.

In some embodiments, in the pseudo instance classification portion 230 to train the MIL classification model 102, two representative feature vectors can be maintained; one for negative instances and the other for positive instances, as prototype vectors μᵣ∈ [symbol] ^{d}, r=0, 1. The generation of pseudo labels and the updating process of prototypes are also guided by true negative instances. That is, if a current text content instance, x_{i,j}, comes from a positive bag, a respective embedding, q_{i,j}, and the prototype vectors μᵣ are used to generate respective pseudo label s_{i,j}∈ [symbol] ². At the same time, the prototype vector of the corresponding class is updated using its predicted label, ŷ_{i,j}, and embedding q_{i,j}. If the current text content instance, x_{i,j}, comes from a negative bag, the instance is assigned a negative label and the negative prototype vector is updated using its embedding, q_{i,j}. Subsequently, the generated pseudo labels are used to train the MIL classification model 102 to complete a current iteration.

For iterations of pseudo label generation, if a current text content instance, x_{i,j}, comes from a positive bag, an inner product is calculated between its embedding, q_{i,j}, and the two prototype vectors, μᵣ, and a prototype label with the smaller feature distance in the common embedding space is selected as the update direction, z_{i,j}∈ [symbol] ², for the pseudo label of x_{i,j}. Then, a moving updating strategy can be used to update the pseudo label of the instance, which can be defined according to equation two (2), which follows:

$${s}_{i , j} = {α}_{{s}_{i , j}} + {( 1 - α )}_{{z}_{i , j}} , {z}_{i , j} = onehot ( arg {max}_{{q}_{i , j}} T {μ}_{r} ) , \qquad ( 2 )$$

where α is a coefficient for moving updating, and onehot(·) is a function that converts a value to a two-dimensional one-hot vector. The moving updating strategy can make the process of updating pseudo labels smoother and more stable.

For prototype updating, if the text content current instance, x_{i,j}, comes from a positive bag, the corresponding prototype vector, μ_{c}, is updated according to its predicted category, ŷ_{i,j}, and embedding, q_{i,j}, using a moving updating strategy according to equation three (3), as follows:

$${μ}_{c} = Norm ( {{βμ}_{c} ( 1 - β )}_{{q}_{i , j}} , c = arg max {\hat{y}}_{i , j} , \qquad ( 3 )$$

where β is a coefficient for moving updating and Norm(·) is the normalization function. Alternatively, if the current instance, x_{i,j}, comes from a negative bag, (i.e., x_{i,j} is a true negative instance) the negative prototype vector, μ₀, is updated using its embedding, q_{i,j}, according to equation four (4), as follows:

$${μ}_{0} = Norm ( {{βμ}_{0} ( 1 - β )}_{{q}_{i , j}} . \qquad ( 4 )$$

In the pseudo instance classification portion 230 of the embodiment of FIG. 2, the pseudo instance classification module 130 can further determine an instance classification loss, [symbol] _{cls}, 234 (e.g., cross-entropy loss) between the predicted value p_{i,j}∈ [symbol] ² of the instance classifier and the pseudo label s_{i,j} to further train the instance classifier according to equation five (5), which follows:

$${ℒ}_{cls} = CE ( {p}_{i , j} , {s}_{i , j} ) , \qquad ( 5 )$$

where CE(·) represents the cross-entropy loss function.

Referring back to FIG.1, in some embodiments of the present principles, to further train the MIL classification model 102, the total loss module 140 of the MIL text classification system 100 of FIG. 1 can compute a triple loss (combined loss) including the contrastive learning loss, [symbol] _{CL}, instance classification loss, [symbol] _{cls}, and the bag constraint loss, [symbol] _{bc}, which can be defined according to equation six (6), which follows:

$${ℒ}_{T} = {ℒ}_{C L} + {λ}_{1} {ℒ}_{c l s} + {λ}_{2} {ℒ}_{b c} , \qquad ( 6 )$$

where λ₁ and λ₂ are optional weight coefficients that can be used for balancing. The combined loss of the present principles is used to guide the training of the MIL classification model 102.

In some embodiments of the present principles, to further train the MIL classification model 102 of the present principles, the paraphrasing module 145 of the MIL text classification system 100 of FIG. 1 can use paraphrasing techniques to generate variations of at least one instance within bag(s). For example, in some embodiments, the paraphrasing module 145 can slightly modify features of at least one text content instance to create at least one paraphrased instance. The paraphrased instance(s) expands the training dataset by creating new instances that have slightly different wordings/phrases/documents but retain the same meaning (e.g., semantic meaning). That is, in some embodiments, the paraphrased instances can be used to train a text classifier of the present principles as described above, and, for example, by creating vector representations of the paraphrased instances and embedding such paraphrased instances into the above described embedding space. By training on both the original instances and the paraphrased versions, a text classifier (e.g., MIL classification model 102) of the present principles becomes more robust to variations in wording and language style.

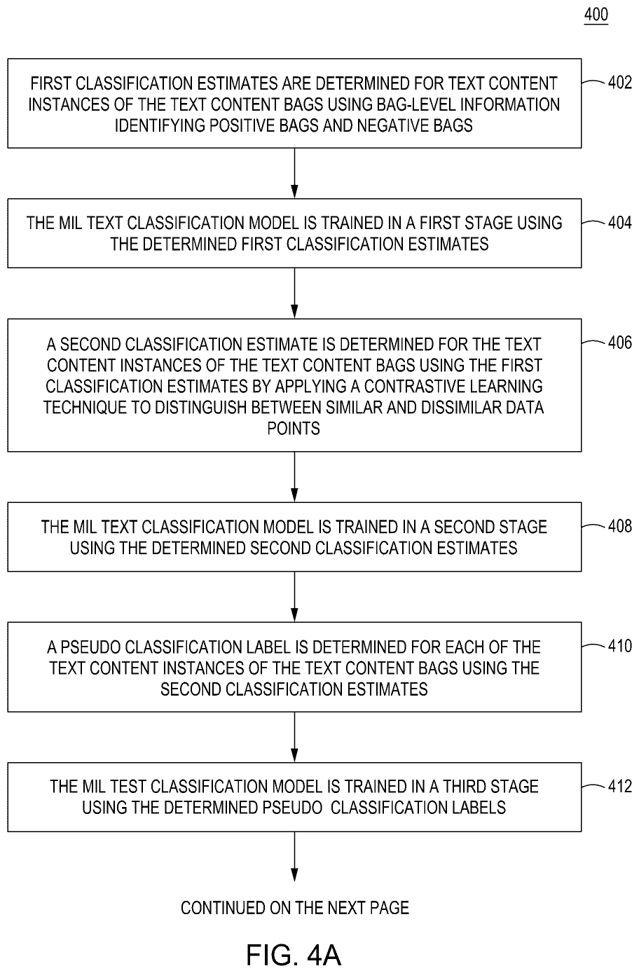

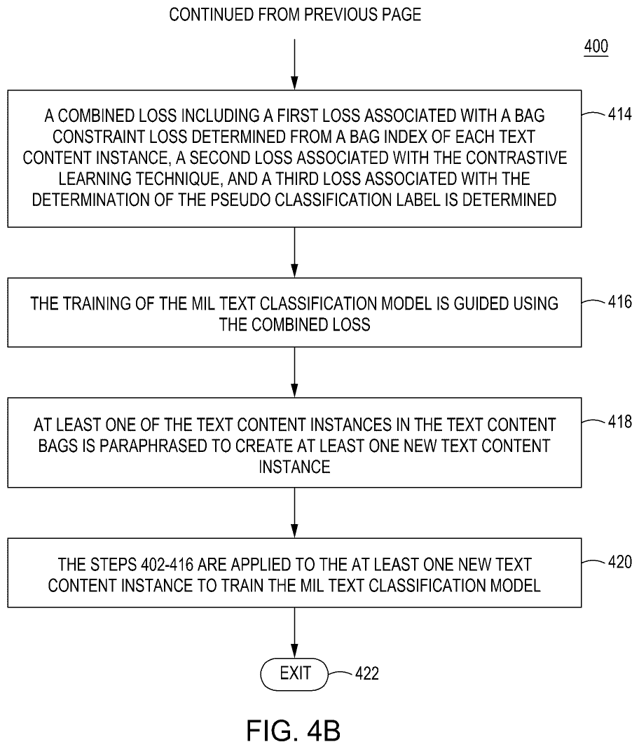

FIG. 4A and 4B depict a flow diagram of a method 400 for training a MIL text classification model to classify text content bags as positive or negative for a specific text characteristic in accordance with an embodiment of the present principles. The method 400 of FIG. 4A and 4B can begin at 402 during which first classification estimates are determined for text content instances of the text content bags using bag-level information identifying positive bags and negative bags. The method 400 can proceed to 404.

At 404, the MIL text classification model is trained in a first stage using the determined first classification estimates. The method 400 can proceed to 406.

At 406, a second classification estimate is determined for the text content instances of the text content bags using the first classification estimates by applying a contrastive learning technique to distinguish between similar and dissimilar data points. The method 400 can proceed to 408.

At 408, the MIL text classification model is trained in a second stage using the determined second classification estimates. The method 400 can proceed to 410.

At 410, a pseudo classification label is determined for each of the text content instances of the text content bags using the second classification estimates. The method 400 can proceed to 412.

At 412, the MIL text classification model is trained in a third stage using the determined pseudo classification labels. The method can proceed to 414.

At 414, a combined loss including a first loss associated with a bag constraint loss determined from a bag index of each text content instance, a second loss associated with the contrastive learning technique, and a third loss associated with the determination of the pseudo classification label is determined. The method 400 can proceed to 416.

At 416, the training of the MIL text classification model is guided using the combined loss. The method 400 can proceed to 418.

At 418, at least one of the text content instances in the text content bags is paraphrased to create at least one new text content instance. The method 400 can proceed to 420.

At 420, the steps 402-416 are applied to the at least one new text content instance to train the MIL text classification model. The method 400 can proceed to 422.

At 422, the method 400 can be exited.

In some embodiments, in the method 400 determining a first classification estimate for text content instances of the text content bags includes classifying text content instances in identified negative text content bags as negative text content instances, determining a respective vector representation for each of the classified negative text content instances, and embedding the determined respective vector representations in a common embedding space.

In some embodiments, in the method 400 determining a second classification estimate for the instances of the text content bags includes determining characteristics of the negative text content instances, embedding, in the common embedding space, vector representations of each of the text content instances of the text content bags that have similar characteristics to the classified negative text content instances close to the embedded vector representations of the classified negative text content instances, and embedding, in the common embedding space, vector representations of each of the text content instances of the text content bags that do not have similar characteristics to the classified negative text content instances farther from the embedded vector representations of the classified negative text content instances.

In some embodiments, in the method 400 determining a pseudo classification label for each of the text content instances of the text content bags includes determining a pseudo classification for each of the text content instances of the text content bags based on the second classification estimate determined using the contrastive learning technique, wherein the pseudo classification includes a weight based on a degree of similarity or difference between a subject text content instance and an embedded vector representation of at least one negative text content instance.

In some embodiments, the pseudo classification label comprises a moving label which is updated in subsequent iterations based on an average of the negative text content instances and/or the positive text content instances.

In some embodiments, the text content characteristic comprises an identifiable text characteristic including at least one of malicious user messages, events of social unrest, business proposals, or content creator classifications such as author's biased statements.

In some embodiments, an apparatus for training a multiple instance learning (MIL) classifier for classifying text content bags includes a processor and a memory accessible to the processor, the memory having stored therein at least one of programs or instructions. In some embodiments, when the programs or instructions are executed by the processor, the apparatus is configured to a) determine a first classification estimate for text content instances of the text content bags using bag-level information identifying positive bags and negative bags, b) train the MIL classifier in a first stage using the determined first classification estimates, c) determine a second classification estimate for the text content instances of the text content bags using the first classification estimates by applying a contrastive learning technique to distinguish between similar and dissimilar data points, d) train the MIL classifier in a second stage using the determined second classification estimates, e) determine a pseudo classification label for each of the text content instances of the text content bags using the second classification estimates, f) train the MIL classifier in a third stage using the determined pseudo classification labels, g) determine a combined loss including a first loss associated with a bag constraint loss determined from a bag index of each text content instance, a second loss associated with the contrastive learning technique, and a third loss associated with the determination of the pseudo classification label, and h) guide the training of the MIL classifier using the combined loss.

In some embodiments, the apparatus is further configured to i) paraphrase at least one of the text content instances in the text content bags to create at least one new text content instance, and j) repeat steps a) through h) to train the MIL classifier using the at least one new text content instance.

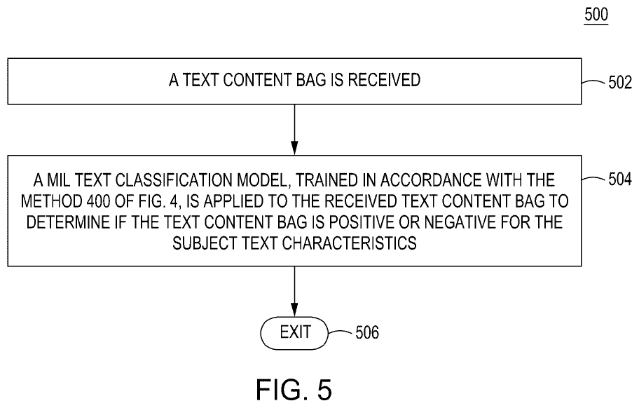

FIG. 5 depicts a flow diagram of a method for classifying a text content bag as positive or negative for a specific text characteristic in accordance with an embodiment of the present principles. The method 500 can begin at 502 during which a text content bag is received. The method 500 can proceed to 504.

At 504, a trained MIL text classification model, trained in accordance with the method 400 is applied to the received text content bag to determine if the text content bag is positive or negative for the specific text characteristic. The method 500 can be exited at 506.

In some embodiments, an apparatus for classifying a text content bag includes a processor and a memory accessible to the processor, the memory having stored therein at least one of programs or instructions. In some embodiments when the program or instructions are executed by the processor, the apparatus is configured to receive a text content bag including text content instances, and apply a trained multiple instance learning (MIL) text classification model to the received text content bag to determine if the text content bag is positive or negative for a text characteristic, wherein the MIL text classification model is trained using a method including a) determining a first classification estimate for text content instances of the text content bags using bag-level information identifying positive bags and negative bags, b) training the MIL classifier in a first stage using the determined first classification estimates, c) determining a second classification estimate for the text content instances of the text content bags using the first classification estimates by applying a contrastive learning technique to distinguish between similar and dissimilar data points, d) training the MIL classifier in a second stage using the determined second classification estimates, e) determining a pseudo classification label for each of the text content instances of the text content bags using the second classification estimates, f) training the MIL classifier in a third stage using the determined pseudo classification labels, g) determining a combined loss including a first loss associated with a bag constraint loss determined from a bag index of each text content instance, a second loss associated with the contrastive learning technique, and a third loss associated with the determination of the pseudo classification label, and h) guiding the training of the MIL classifier using the combined loss.

In some embodiments, the MIL text classification model is further trained by i) paraphrasing at least one of the text content instances in the text content bags to create at least one new text content instance, and j) repeating steps a) through h) to train the MIL classifier using the at least one new text content instance.

As depicted in FIG. 1, embodiments of a MIL text classification system of the present principles, such as the MIL text classification system 100 of FIG. 1, can be implemented in a computing device 600 in accordance with embodiments of the present principles. That is, in some embodiments, content, such as text content bags and the like can be communicated to components of the MIL text classification system 100 of FIG. 1 using the computing device 600 via, for example, any input/output means associated with the computing device 600. Data associated with a MIL text classification system in accordance with the present principles can be presented to a user using an output device of the computing device 600, such as a display, a printer or any other form of output device.

For example, FIG. 6 depicts a high-level block diagram of a computing device 600 suitable for use with embodiments of a MIL text classification system in accordance with the present principles such as the MIL text classification system 100 of FIG. 1. In some embodiments, the computing device 600 can be configured to implement methods of the present principles as processor-executable executable program instructions 622 (e.g., program instructions executable by processor(s) 610) in various embodiments.

In the embodiment of FIG. 6, the computing device 600 includes one or more processors 610a-610n coupled to a system memory 620 via an input/output (I/O) interface 630. The computing device 600 further includes a network interface 650 coupled to I/O interface 630, and one or more input/output devices 650, such as cursor control device 660, keyboard 670, and display(s) 680. In various embodiments, a user interface can be generated and displayed on display 680. In some cases, it is contemplated that embodiments can be implemented using a single instance of computing device 600, while in other embodiments multiple such systems, or multiple nodes making up the computing device 600, can be configured to host different portions or instances of various embodiments. For example, in one embodiment some elements can be implemented via one or more nodes of the computing device 600 that are distinct from those nodes implementing other elements. In another example, multiple nodes may implement the computing device 600 in a distributed manner.

In different embodiments, the computing device 600 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 600 can be a uniprocessor system including one processor 610, or a multiprocessor system including several processors 610 (e.g., two, four, eight, or another suitable number). Processors 610 can be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 can be configured to store program instructions 622 and/or data 632 accessible by processor 610. In various embodiments, system memory 620 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 620. In other embodiments, program instructions and/or data can be received, sent or stored upon different types of computer-accessible media or on similar media separate from system memory 620 or computing device 600.

In one embodiment, I/O interface 630 can be configured to coordinate I/O traffic between processor 610, system memory 620, and any peripheral devices in the device, including network interface 640 or other peripheral interfaces, such as input/output devices 650. In some embodiments, I/O interface 630 can perform any necessary protocol, timing or other data transformations to convert data signals from one component (e.g., system memory 620) into a format suitable for use by another component (e.g., processor 610). In some embodiments, I/O interface 630 can include support for devices attached through various types of peripheral buses, such as a variant of the Peripheral Component Interconnect (PCI) bus standard or the Universal Serial Bus (USB) standard, for example. In some embodiments, the function of I/O interface 630 can be split into two or more separate components, such as a north bridge and a south bridge, for example. Also, in some embodiments some or all of the functionality of I/O interface 630, such as an interface to system memory 620, can be incorporated directly into processor 610.

Network interface 640 can be configured to allow data to be exchanged between the computing device 600 and other devices attached to a network (e.g., network 690), such as one or more external systems or between nodes of the computing device 600. In various embodiments, network 690 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 650 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 650 can, in some embodiments, include one or more display terminals, keyboards, keypads, touchpads, scanning devices, voice or optical recognition devices, or any other devices suitable for entering or accessing data by one or more computer systems. Multiple input/output devices 650 can be present in computer system or can be distributed on various nodes of the computing device 600. In some embodiments, similar input/output devices can be separate from the computing device 600 and can interact with one or more nodes of the computing device 600 through a wired or wireless connection, such as over network interface 640.

Those skilled in the art will appreciate that the computing device 600 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 600 can also be connected to other devices that are not illustrated or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 600 can communicate with other computing devices based on various computer communication protocols such a Wi-Fi, Bluetooth.RTM. (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 600 is depicted as a general purpose computer, the computing device 600 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

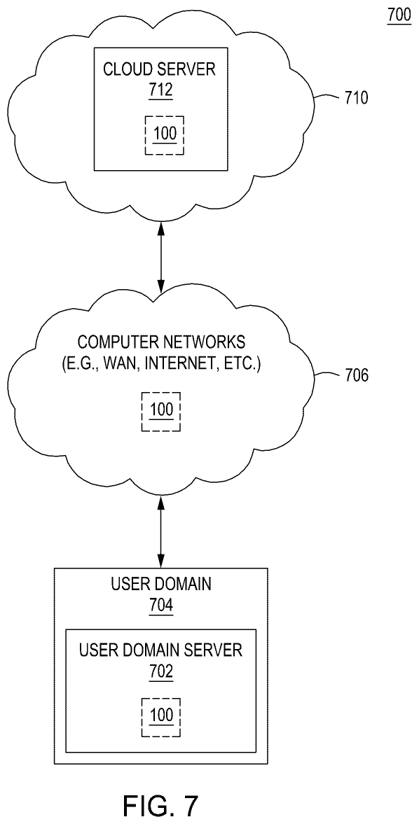

FIG. 7 depicts a high-level block diagram of a network environment in which embodiments of a MIL text classification system in accordance with the present principles, such as the MIL text classification system 100 of FIG. 1, can be applied. The network environment 700 of FIG. 7 illustratively comprises a user domain 702 including a user domain server/computing device 704. The network environment 700 of FIG. 7 further comprises computer networks 706, and a cloud environment 710 including a cloud server/computing device 712.

In the network environment 700 of FIG. 7, a system for MIL text classification in accordance with the present principles, such as the MIL text classification system 100 of FIG. 1, can be included in at least one of the user domain server/computing device 704, the computer networks 706, and the cloud server/computing device 712. That is, in some embodiments, a user can use a local server/computing device (e.g., the user domain server/computing device 704) to provide the functionalities of a MIL text classification system in accordance with the present principles.

In some embodiments, a user can implement a system for MIL text classification in the computer networks 706 to train an MIL text classifier for classifying text content bags in accordance with the present principles. Alternatively or in addition, in some embodiments, a user can implement a system for MIL text classification in the cloud server/computing device 712 of the cloud environment 710 to train an MIL text classifier for classifying text content bags in accordance with the present principles. For example, in some embodiments it can be advantageous to perform processing functions of the present principles in the cloud environment 710 to take advantage of the processing capabilities and storage capabilities of the cloud environment 710. In some embodiments in accordance with the present principles, a MIL text classification system for training an MIL text classifier for classifying text content bags can be located in a single and/or multiple locations/servers/computers to perform all or portions of the herein described functionalities of a MIL text classification system in accordance with the present principles. For example, in some embodiments some components of a MIL text classification system of the present principles can be located in one or more than one of the a user domain 702, the computer network environment 706, and the cloud environment 710 while other components of the present principles can be located in at least one of the user domain 702, the computer network environment 706, and the cloud environment 710 for providing the functions described above either locally or remotely.

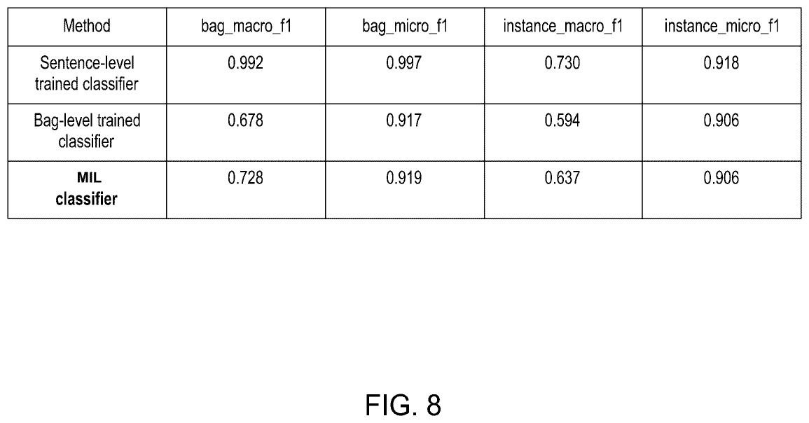

In an experiment, the inventors trained an MIL classifier at a sentence level using 1866 positive sentences and 14300 negative sentences. The inventors further trained an MIL classifier at a bag (document) level using 307 positive documents and 50 negative documents. In the same experiment and using the same training data, the inventors trained an MIL classifier in accordance with the present principes described herein. FIG. 8 depicts a Table of the results of the sentence-level-trained MIL classifier, the bag-level-trained classifier and a MIL classifier trained in accordance with the present principles when applied to evaluation data. As depicted in the first row of the Table of FIG. 8, for the instance-level-trained classifier, when evaluating bags at a macro level, the result is 0.992; when evaluating bags at the micro level the result is 0.997, when evaluating instances at the macro level the result is 0.730, and when evaluating the instances at the micro level the result is 0.918. As depicted in the second row of the Table of FIG. 8, for the bag-level-trained classifier, when evaluating bags at a macro level, the result is 0.678; when evaluating bags at the micro level the result is 0.917, when evaluating instances at the macro level the result is 0.594, and when evaluating the instances at the micro level the result is 0.906. Finally, as depicted in the third row of the Table of FIG. 8, for the MIL classifier trained in accordance with the present principles, when evaluating bags at a macro level, the result is 0.728; when evaluating bags at the micro level the result is 0.919, when evaluating instances at the macro level the result is 0.637, and when evaluating the instances at the micro level the result is 0.906.

As can be determined from the results presented in the Table of FIG. 8, although the sentence-level-trained classifier seems to produce the best results, the sentence-level-trained classifier requires 45 times as much labeled data to train. As can be determined from the results presented in the Table of FIG. 8, the bag-level-trained classifier, although uses the least amount of data for training, produces the worst results. As further determinable from the results presented in the Table of FIG. 8, the MIL classifier trained in accordance with the present principles recovers some of the difference between the results of the sentence-level-trained classifier and the bag-level-trained classifier and specifically recovers 32% in the instance macro level and recovers 16% in the bag macro level.

Embodiments of a MIL classifier (model) of the present principles can be used to identify instances and/or bags that are positive for (include) specific content characteristics of interest including, but not limited to, malicious user language, events of social unrest, business proposals, content creator classifications such as authors, biased statements and any other content-based characteristics.

In some embodiments, the text content multiple instance learning of the present principles has many potential applications, for example, where labeling every piece of text is prohibitively expensive. For example, in trigger warning detection applications in stories or television programs in which particular content can be traumatic for individuals, a MIL text classification system of the present principles, such as the MIL text classification system 100 of FIG. 1, and a MIL text classification model of the present principles can learn to identify and localize such content with just a label at the bag level (story or television show). Other applications can include classification of malicious messages from a user (either coarse language or phishing attempts). That is, in some embodiments a user can be flagged because of a single message in a group (bag) of messages. In other embodiments, a MIL text classification system of the present principles, such as the MIL text classification system 100 of FIG. 1, and a MIL text classification model of the present principles can be implemented in political bias detection since not every piece of content from an organization will reflect a bias. In such embodiments, documents or sources can be flagged with a biased label and embodiments of the present principles can be implemented to mine their textual communications to identify which communications exhibit the bias.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 600 can be transmitted to the computing device 600 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. These and other variations, modifications, additions, and improvements can fall within the scope of embodiments as defined in the claims that follow.

1. A method for training a multiple instance learning (MIL) classifier for classifying text content bags as positive or negative for including a text content characteristic, comprising:
a) determining a first classification estimate for text content instances of the text content bags using bag-level information identifying positive bags and negative bags;
b) training the MIL classifier in a first stage using the determined first classification estimates;
c) determining a second classification estimate for the text content instances of the text content bags using the first classification estimates by applying a contrastive learning technique to distinguish between similar and dissimilar data points;
d) training the MIL classifier in a second stage using the determined second classification estimates;
e) determining a pseudo classification label for each of the text content instances of the text content bags using the second classification estimates;
f) training the MIL classifier in a third stage using the determined pseudo classification labels;
g) determining a combined loss including a first loss associated with a bag constraint loss determined from a bag index of each text content instance, a second loss associated with the contrastive learning technique, and a third loss associated with the determination of the pseudo classification label;
h) guiding the training of the MIL classifier using the combined loss;
i) paraphrasing at least one of the text content instances in the text content bags to create at least one new text content instance; and
j) repeating steps a) through h) to train the MIL classifier using the at least one new text content instance.

2. The method of claim 1, wherein determining a first classification estimate for text content instances of the text content bags comprises at least:
classifying text content instances in identified negative text content bags as negative text content instances;
determining a respective vector representation for each of the classified negative text content instances; and
embedding the determined respective vector representations in a common embedding space.

3. The method of claim 2, wherein determining a second classification estimate for the instances of the text content bags comprises at least:
determining characteristics of the negative text content instances;
embedding, in the common embedding space, vector representations of each of the text content instances of the text content bags that have similar characteristics to the classified negative text content instances close to the embedded vector representations of the classified negative text content instances; and
embedding, in the common embedding space, vector representations of each of the text content instances of the text content bags that do not have similar characteristics to the classified negative text content instances farther from the embedded vector representations of the classified negative text content instances.

4. The method of claim 1, wherein determining a pseudo classification label for each of the text content instances of the text content bags comprises at least:
determining a pseudo classification for each of the text content instances of the text content bags based on the second classification estimate determined using the contrastive learning technique; and
wherein the pseudo classification includes a weight based on a degree of similarity or difference between a subject text content instance and an embedded vector representation of at least one negative text content instance.

5. The method of claim 1, wherein the pseudo classification label comprises a moving label which is updated in subsequent iterations based on an average of the negative text content instances and/or the positive text content instances.

6. The method of claim 1, wherein the text content characteristic comprises an identifiable text characteristic including at least one of malicious user messages, events of social unrest, business proposals, or content creator classifications such as author's biased statements.

7. A method for classifying a text content bag, comprising:
receiving a text content bag including text content instances; and
applying a trained multiple instance learning (MIL) text classification model to the received text content bag to determine if the text content bag is positive or negative for a text characteristic, wherein the MIL text classification model is trained using a method comprising:
a) determining a first classification estimate for text content instances of the text content bags using bag-level information identifying positive bags and negative bags;
b) training the MIL classifier in a first stage using the determined first classification estimates;
c) determining a second classification estimate for the text content instances of the text content bags using the first classification estimates by applying a contrastive learning technique to distinguish between similar and dissimilar data points;
d) training the MIL classifier in a second stage using the determined second classification estimates;
e) determining a pseudo classification label for each of the text content instances of the text content bags using the second classification estimates;
f) training the MIL classifier in a third stage using the determined pseudo classification labels;
g) determining a combined loss including a first loss associated with a bag constraint loss determined from a bag index of each text content instance, a second loss associated with the contrastive learning technique, and a third loss associated with the determination of the pseudo classification label;
h) guiding the training of the MIL classifier using the combined loss;
i) paraphrasing at least one of the text content instances in the text content bags to create at least one new text content instance; and
j) repeating steps a) through h) to train the MIL classifier using the at least one new text content instance.

8. The method of claim 7, wherein the pseudo classification label comprises a moving label which is updated in subsequent iterations based on an average of the negative text content instances and/or the positive text content instances.

9. The method of claim 7, wherein the text content characteristic comprises an identifiable text characteristic including at least one of malicious user messages, events of social unrest, business proposals, or content creator classifications such as author's biased statements.

10. An apparatus for training a multiple instance learning (MIL) classifier for classifying text content bags as positive or negative for including a text content characteristic, comprising:
a processor; and
a memory accessible to the processor, the memory having stored therein at least one of programs or instructions executable by the processor to configure the apparatus to:
a) determine a first classification estimate for text content instances of the text content bags using bag-level information identifying positive bags and negative bags;
b) train the MIL classifier in a first stage using the determined first classification estimates;
c) determine a second classification estimate for the text content instances of the text content bags using the first classification estimates by applying a contrastive learning technique to distinguish between similar and dissimilar data points;
d) train the MIL classifier in a second stage using the determined second classification estimates;
e) determine a pseudo classification label for each of the text content instances of the text content bags using the second classification estimates;
f) train the MIL classifier in a third stage using the determined pseudo classification labels;
g) determine a combined loss including a first loss associated with a bag constraint loss determined from a bag index of each text content instance, a second loss associated with the contrastive learning technique, and a third loss associated with the determination of the pseudo classification label; and
h) guide the training of the MIL classifier using the combined loss.

11. The apparatus of claim 10, wherein the apparatus is further configured to:
i) paraphrase at least one of the text content instances in the text content bags to create at least one new text content instance; and
j) repeat steps a) through h) to train the MIL classifier using the at least one new text content instance.

12. The apparatus of claim 10, wherein determining a first classification estimate for text content instances of the text content bags comprises at least:
classifying text content instances in identified negative text content bags as negative text content instances;
determining a respective vector representation for each of the classified negative text content instances; and
embedding the determined respective vector representations in a common embedding space.

13. The apparatus of claim 12, wherein determining a second classification estimate for the instances of the text content bags comprises at least:
determining characteristics of the negative text content instances;
embedding, in the common embedding space, vector representations of each of the text content instances of the text content bags that have similar characteristics to the classified negative text content instances close to the embedded vector representations of the classified negative text content instances; and
embedding, in the common embedding space, vector representations of each of the text content instances of the text content bags that do not have similar characteristics to the classified negative text content instances farther from the embedded vector representations of the classified negative text content instances.

14. The apparatus of claim 10, wherein determining a pseudo classification label for each of the text content instances of the text content bags comprises at least:
determining a pseudo classification for each of the text content instances of the text content bags based on the second classification estimate determined using the contrastive learning technique; and
wherein the pseudo classification includes a weight based on a degree of similarity or difference between a subject text content instance and an embedded vector representation of at least one negative text content instance.

15. The apparatus of claim 10, wherein the pseudo classification label comprises a moving label which is updated in subsequent iterations based on an average of the negative text content instances and/or the positive text content instances.

16. The apparatus of claim 10, wherein the text content characteristic comprises an identifiable text characteristic including at least one of malicious user messages, events of social unrest, business proposals, or content creator classifications such as author's biased statements.

17. An apparatus for classifying a text content bag, comprising:
a processor; and
a memory accessible to the processor, the memory having stored therein at least one of programs or instructions executable by the processor to configure the apparatus to:
receive a text content bag including text content instances; and
apply a trained multiple instance learning (MIL) text classification model to the received text content bag to determine if the text content bag is positive or negative for a text characteristic, wherein the MIL text classification model is trained using a method comprising:
a) determining a first classification estimate for text content instances of the text content bags using bag-level information identifying positive bags and negative bags;
b) training the MIL classifier in a first stage using the determined first classification estimates;
c) determining a second classification estimate for the text content instances of the text content bags using the first classification estimates by applying a contrastive learning technique to distinguish between similar and dissimilar data points;
d) training the MIL classifier in a second stage using the determined second classification estimates;
e) determining a pseudo classification label for each of the text content instances of the text content bags using the second classification estimates;
f) training the MIL classifier in a third stage using the determined pseudo classification labels;
g) determining a combined loss including a first loss associated with a bag constraint loss determined from a bag index of each text content instance, a second loss associated with the contrastive learning technique, and a third loss associated with the determination of the pseudo classification label; and
h) guiding the training of the MIL classifier using the combined loss.

18. The apparatus of claim 17, wherein the method further comprises:
i) paraphrasing at least one of the text content instances in the text content bags to create at least one new text content instance; and
j) repeating steps a) through h) to train the MIL classifier using the at least one new text content instance.

19. The apparatus of claim 17, wherein the pseudo classification label comprises a moving label which is updated in subsequent iterations based on an average of the negative text content instances and/or the positive text content instances.

20. The apparatus of claim 17, wherein the text content characteristic comprises an identifiable text characteristic including at least one of malicious user messages, events of social unrest, business proposals, or content creator classifications such as author's biased statements.
